(19) United States
(12) Patent Application Publication
(10) Pub. No.: US 2015/0019265 A1
(43) Pub. Date: Jan. 15, 2015

(54) BUNDLING INSURANCE POLICIES AND INVESTMENT ACCOUNTS

(71) Applicant: STATE FARM MUTUAL AUTOMOBILE INSURANCE COMPANY, Bloomington, IL (US)

(72) Inventors: Leif A. Roll, Bloomington, IL (US); Vernon G. Brogla, Normal, IL (US); Scott Hintz, Bloomington, IL (US); Zupei Luo, Normal, IL (US); Alan R. Hendren, Bloomington, IL (US)

(73) Assignee: STATE FARM MUTUAL AUTOMOBILE INSURANCE COMPANY, Bloomington, IL (US)

(21) Appl. No.: 14/107,621

(22) Filed: Dec. 16, 2013

Related U.S. Application Data
(62) Division of application No. 13/941,402, filed on Jul. 12, 2013.

(51) Int. Cl. G06Q 40/08

(52) U.S. Cl. CPC G06Q 40/08; G06Q 40/06
USPC 705/4

(57) ABSTRACT

Methods and systems for bundling an insurance policy and an account of an investment vehicle include determining if the policy and/or the account is eligible for inclusion in a bundled product, generating an indication of the bundled product, and causing the indication to be transmitted to a user interface and/or computing device. The eligibility determination is based on a state or status of the policy and/or a state or status of the account, and optionally is based on characteristics and/or conditions associated with the policy and/or the account. A bundling benefit may be enacted. The bundling benefit may include, for example, a discount or waiver on a fee, charge or load of the investment account, and/or a discount or waiver of a premium of the insurance policy. The insurance policy may correspond to any type of insurance, and the investment account may correspond to any type of investment vehicle.

### RELATED APPLICATIONS

This application is a division of and claims priority to U.S. patent application Ser. No. 13/941,402 filed on Jul. 12, 2013 and entitled “Bundling Insurance Policies and Investment Accounts,” the entire disclosure of which is expressly hereby incorporated by reference herein.

### FIELD OF THE DISCLOSURE

This disclosure generally relates to insurance policies and investment accounts, and in particular, to combining or bundling insurance policies and investment accounts.

### BACKGROUND

Insurance companies or insurance providers join insurance products or services together to sell as a single combined unit or as related units, commonly known as “bundling.” Bundling allows a customer to obtain multiple products or services from a single provider at a lower cost and/or with greater convenience than if the customer obtained the products individually. For example, when a homeowners' insurance policy and an automobile insurance policy are bundled, the amount of the total premium of the bundled product is less than the sum of the individual premiums of the unbundled policies. In another example, an insurance provider offers a discount on premiums of an auto insurance policy if a customer has a current life insurance policy. In some cases, the insurance company combines the premium payments across multiple insurance policies into one payment for customer convenience.

Companies that have traditionally offered insurance products or services are expanding into the financial products market. For example, traditional insurance companies or providers are starting to offer investment vehicles such as mutual fund accounts, checking and savings accounts, money market accounts, retirement accounts, exchange-traded fund accounts (ETFs), brokerage accounts, and investment management accounts.

### SUMMARY

In an embodiment, a method of bundling insurance policies and investment accounts includes determining an eligibility or ineligibility of a first product for bundling with a second product to create or form a bundled set of products. The first product may be one of an insurance policy or an investment account, and the second product may be the other one of the insurance policy or the investment account. The determination of the eligibility of the first product for bundling may be based on a status of the first product, and may additionally be based on other characteristics or conditions corresponding to the first product. The method further includes generating, based on the eligibility and/or ineligibility of the first product for bundling, an indication corresponding to the bundled set of products, and causing the indication corresponding to the bundled set of products to be transmitted to a user interface and/or to a computing device. In an embodiment, the method may also include determining the eligibility or ineligibility of the second product for bundling with the first product. At least a portion of the method may be performed by a computing device or system.

In an embodiment, a system for bundling insurance policies and investment accounts includes a computing device having a processor and a memory; and a set of computer-executable instructions stored on the memory. The computer-executable instructions are executable by the processor to cause the computing device to determine an eligibility and/or an ineligibility of a first product for bundling with a second product to create or form a bundled set of products, where the first product is one of an insurance policy or an investment account corresponding to a party, and the second product is the other one of the insurance policy or the investment account corresponding to the party. The determination of the eligibility and/or ineligibility of the first product for bundling may be based on a status of the first product, and may additionally be based on other characteristics or conditions corresponding to the first product. The computer-executable instructions are further executable to generate an indication corresponding to the bundled set of products based on the determination of the eligibility and/or ineligibility of the first product for bundling. In an embodiment, the computer-executable instructions are still further to cause the computing device to determine an eligibility and/or an ineligibility of the second product for bundling with the first product to create or form the bundled set of products

In an embodiment, a system for bundling insurance policies and investment accounts includes a processor and one or more data storage devices accessible to the processor. The one or more data storage devices are configured to store an entry corresponding to a party, where the entry includes (i) an insurance policy status indicator configured to store a status of an insurance policy corresponding to the party, and (ii) an investment account status indicator configured to store a status of an investment account corresponding to the party. The system further includes a program memory storing executable instructions that, when executed by the processor, cause the system to update at least one of (i) the insurance policy status indicator corresponding to a change in status of the insurance policy, or (ii) the investment account status indicator corresponding to a change in the status of the investment account.

### BRIEF DESCRIPTION OF THE DRAWINGS

FIG. 1 is an example method of bundling insurance policies and investment accounts;

FIG. 2 is an example block diagram of a system for bundling insurance policies and investment accounts;

FIG. 3 is an example scenario of bundling insurance policies and investment accounts; and

FIG. 4 is an example scenario of bundling insurance policies and investment accounts.

### DETAILED DESCRIPTION

The novel methods and systems disclosed herein generally relate to the bundling or combining of an insurance policy and an account of an investment vehicle so that the insurance policy and the investment account are related, tied together, or marketed/sold as a single combined unit. In some scenarios, the bundling of an insurance policy product and an investment vehicle product may be referred to as a “multi-line discount,” e.g., when a same entity offers or provides both the insurance policy product and the investment vehicle product.

Bundling or multi-line discounts may result in financial and/or convenience benefits to customers. For example, a customer of a bundled insurance policy and investment vehicle account may receive a discount on the insurance premium. Alternatively or additionally, the customer of the bundled product may receive a discount, reduction or waiver of fees, loads, or sales charges associated with the investment account, and/or may receive a higher rate of return or an increased dividend. Other bundling benefits may be possible. The bundling benefits of the bundled product may continue as long as the insurance policy remains in-force and the investment account remains open, for example.

The bundling of an insurance policy and an investment account may also result in benefits to providers of the insurance policies and to providers of the investment vehicles (which, in some cases, may be the same provider). For example, by offering bundled insurance policies and investment accounts, providers may attract a wider customer base, may increase sales, and/or may increase profits.

Bundled sets of products including insurance policies and investment vehicle accounts must meet insurance regulatory and actuarial standards as well as securities regulations. Furthermore, bundled sets of insurance policies and investment vehicle accounts must comply with all applicable local, state and federal laws.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Accordingly, the term “insurance policy,” as used herein, generally refers to a contract between an insurer and an insured. In exchange for payments from the insured, the insurer pays for damages to the insured which are caused by covered perils, acts or events as specified by the language of the insurance policy. The payments from the insured are generally referred to as “premiums,” and typically are paid on behalf of the insured over time at periodic intervals. The amount of the damages payment is generally referred to as a “coverage amount” or a “face amount” of the insurance policy. An insurance policy may remain (or have a status or state of) “in-force” while premium payments are made during the term or length of coverage of the policy as indicated in the policy. An insurance policy may “lapse” (or have a status or state of “lapsed”), for example, when premium payments are not being paid, when a cash value of a policy falls below an amount specified in the policy (e.g., for variable life or universal life insurance policies), or if the insured or the insurer cancels the policy.

The terms “insurer,” “insuring party,” and “insurance provider” are used interchangeably herein to generally refer to a party or entity (e.g., a business or other organizational entity) that provides insurance products, e.g., by offering and issuing insurance policies. Typically, but not necessarily, an insurance provider may be an insurance company.

An insurance provider may provide one or more different types of insurance, insurance products, or insurance policies, any one or more of which may be bundled with an investment account. Types of insurance, insurance products, or insurance policies may include, for example, auto insurance; homeowners insurance; condominium owner insurance; renter's insurance; life insurance (e.g., whole-life, universal, variable, term, etc.); health insurance; disability insurance; long-term care insurance; annuities; business insurance (e.g., property, liability, commercial auto, workers compensation, professional and specialty liability, inland marine and mobile property, surety and fidelity bonds, etc.); boat insurance; insurance for catastrophic events such as flood, fire, volcano damage and the like; motorcycle insurance; farm and ranch insurance; personal article insurance; personal liability insurance; personal umbrella insurance; community organization insurance (e.g., for associations, religious organizations, cooperatives, etc.); and other types of insurance. Based on the current laws and regulations at the time of this disclosure, typically the types of insurance policies which may be bundled with investment accounts correspond to non-tax qualified types of insurance, although this condition may be altered if the laws and/or regulations change.

The terms “insured,” “insured party,” and “policyholder” are used interchangeably herein to refer to a person, party, or entity (e.g., a business or other organizational entity) that is covered by the insurance policy, e.g., whose insured article or entity (e.g., property, life, health, auto, home, business, etc.) is covered by the policy. A “guarantor,” as used herein, generally refers to a person, party or entity that is responsible for payment of the insurance premiums. The guarantor may or may not be the same party as the insured, such as in situations when a guarantor has power of attorney for the insured. In some cases, a guarantor may be an insurance policy owner.

An “annuitant,” as referred to herein, generally refers to a person, party or entity that is entitled to receive benefits from an annuity insurance product offered by the insuring party. The annuitant may or may not be the same party as the guarantor.

Typically, a person or customer (or an agent of the person or customer) of an insurance provider fills out an application for an insurance policy. The application may undergo underwriting to assess the eligibility of the party and/or desired insured article or entity to be covered by the insurance policy, and, in some cases, to determine any specific terms or conditions that are to be associated with the insurance policy, e.g., amount of the premium, riders or exclusions, waivers, and the like. Upon approval by underwriting, acceptance of the applicant to the terms or conditions, and payment of the initial premium, insurance policy may be in-force, e.g., the policyholder is enrolled.

The term “investment vehicle,” as used herein, generally refers to a product used by investors with the intention of having positive financial returns. Types of investment vehicles may include, for example, stocks, bonds, mutual funds (e.g., stock funds, index funds, bond funds, money market funds, mixed asset funds, hedge funds, etc.); retirement accounts; checking accounts; savings accounts; certificate of deposits; education savings accounts; health savings accounts; ETFs; brokerage accounts, investment management accounts; and other types of investment vehicles. Typically, an investor opens an investment account for a particular investment vehicle, and provides an initial contribution that is equivalent to a monetary value. Based on the current laws and regulations at the time of this disclosure, typically the types of investment vehicle accounts which may be bundled with insurance policies correspond to non-tax qualified types of investment vehicles, although this condition may be altered if the laws and/or regulations change.

An investment vehicle provider may offer or provide one or more types of investment vehicles. An account of any type of investment vehicle may be bundled with an insurance policy. In some scenarios, multiple investment accounts of multiple types may be bundled with an insurance policy. A provider of an investment vehicle account may also be the provider of the insurance policy, or the provider of the investment vehicle account may be a party or entity other than the insurance policy provider (e.g., a different company or business, a different corporate entity within the same company, a different organizational entity, or a different other type of entity).

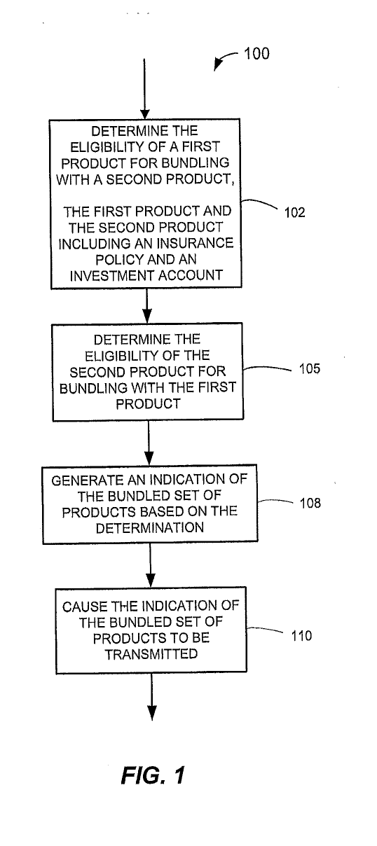

FIG. 1 is an example method 100 for bundling insurance policies and investment accounts. At least a portion of the method 100 may be performed by one or more computing devices, in an embodiment.

The method 100 may include determining an eligibility of a first product for bundling with a second product to form a bundled set of products (block 102). One of the first product or the second product may be an insurance policy, and the other one of the first product or the second product may be an account of an investment vehicle. The insurance policy may be any type of insurance policy, and the investment account may be any type of investment vehicle account. In an embodiment, the insurance policy is a life insurance policy or annuity policy, and the investment account is a mutual fund account.

The insurance policy and the investment account may be associated with or may correspond to a same party or person. In an embodiment, the party corresponding to the insurance policy may be an insured party, an annuitant, a policy owner, a beneficiary, and/or a guarantor of the insurance policy. In an embodiment, the party corresponding to the investment account may be an account owner or investor. In some cases, the party corresponding to the insurance policy and to the investment account may not be a person, but may be an entity such as a business, an organization, or another type of entity.

In an embodiment, the eligibility of a product (e.g., the insurance policy or the investment account) for bundling may be determined based on a state or a status of the product. For example, an insurance policy may be eligible for bundling if the policy is approved or in-force, and the insurance policy may be ineligible for bundling when the policy is applied for but not yet approved, or when the policy is lapsed.

In some cases, the eligibility and/or ineligibility of the insurance policy for bundling may be additionally based on a characteristic or condition of the insurance policy. A characteristic of the insurance policy may be an attribute of the insurance policy that is generally fixed, e.g., an attribute that is defined by the insurance policy. For example, a characteristic of an insurance policy may be a length of term of the policy, or a coverage amount of the policy. A condition of the insurance policy may be an attribute of the insurance policy that may vary while the policy is in-force. For example, a condition of a whole life insurance policy or an annuity policy may be a cash value of the policy, and a condition of an auto insurance policy may be a deductible amount that decreases over time.

The insurance policy may be eligible for bundling if the policy meets a certain characteristic or condition, e.g., the cash value of the insurance policy exceeds a particular value, etc. The eligibility and/or ineligibility of the insurance policy for bundling may be additionally or alternatively based on one or more other characteristics or conditions of the policy, such as a length of term or a fixed or variable deductible amount of the insurance policy. In some embodiments, the eligibility and/or the ineligibility of the insurance policy for bundling may be based on more than one characteristic or condition.

The states, statuses, characteristics, and/or conditions of the insurance policy that contribute to the eligibility and/or ineligibility of the insurance policy for bundling may be reflected by a value stored in a single indicator (e.g., a status indicator of the insurance policy), or may be reflected by values stored in multiple indicators. For example, a first indicator may store a value indicative of the current status of the insurance policy, a second indicator may store a value indicative of whether the premiums have been paid in full to date, and a third indicator may store a value indicative of a coverage amount of the policy. In some embodiments, the multiple indicators may be stored across multiple data storage devices or computing devices.

The particular states, statuses, characteristics, and/or conditions of the insurance policy that contribute to the eligibility and/or ineligibility of the insurance policy for bundling may be defined in a set of insurance policy bundling rules. In an embodiment, a user (e.g. an agent of the insurance provider) may define, select, and/or modify the set of insurance policy bundling rules. In an embodiment, different sets of insurance policy bundling rules may correspond to different types of insurance policies. In an embodiment, different sets of insurance policy bundling rules may correspond to different bundle combinations in which each combination includes the same type of insurance policy and a different type of investment account.

Turning now to accounts of investment vehicles, in an embodiment, an investment vehicle account may be eligible for bundling if the status or state of the account is open, and the investment vehicle account may be ineligible for bundling if the status or state of the account is closed. In some cases, the eligibility and/or ineligibility of the investment account for bundling may be further based on a characteristic or condition of the investment account.

Similar to insurance policies, a characteristic of an investment account may be an attribute of the account that is generally fixed, and may be defined by the terms of the account. For example, a characteristic of the investment account may be a required initial contribution amount or a guaranteed interest rate. A condition of an investment account may be an attribute of the account that may vary over time. For example, a condition of the investment account may be a variable rate of return or a current value of the account.

The investment account may be eligible for bundling if the investment account has a particular characteristic or meets a particular condition, e.g., the balance or monetary value of the account exceeds a specific threshold, or a number of shares included in the account is greater than a given number of shares. The eligibility and/or ineligibility of the investment account for bundling may be additionally or alternatively based on one or more other characteristics or conditions of the account, such as a length of time that the account has been open, or a monetary value of a total investment portfolio that includes the account. In some embodiments, the eligibility and/or ineligibility of the investment account for bundling may be based on more than one characteristic or condition.

The states, statuses, characteristics, and/or conditions of the investment account that contribute to the eligibility and/or ineligibility of the investment account for bundling may be reflected in a value stored in a single indicator (e.g., a status indicator of the investment account), or may be reflected in multiple values stored in multiple indicators. For example, a first indicator may store a value indicative of the current status of the investment account, a second indicator may store a value indicative of whether or not the balance of the account is above a particular threshold, and a third indicator may store a value indicative of a total portfolio value in which the investment account is included. In some embodiments, the multiple indicators may be stored across multiple data storage devices or computing devices.

The particular states, statuses, characteristics, and/or conditions of the investment account that contribute to the eligibility and/or ineligibility of the investment account for bundling may be defined in a set of investment account bundling rules. In an embodiment, a user (e.g., an agent of the investment vehicle account provider) may define, select and/or modify the set of investment account bundling rules. In an embodiment, different sets of investment account bundling rules may correspond to different types of investment accounts. In an embodiment, different sets of investment account bundling rules may correspond to different bundle combinations in which each combination includes the same type of investment account and a different type of insurance policy. In an embodiment, a set of investment account bundling rules may be aggregated with a set of insurance policy bundling rules.

Continuing with the method 100, in an embodiment, determining the eligibility of a product for bundling (block 102) includes receiving an indication that the product is eligible for bundling. In an embodiment, an explicit indication that the product is eligible for bundling may be received. For example, the explicit indication may be received via a user interface, such as when an agent or sales person enters data indicating that the party or customer has approved of or agreed to the bundling of the products, or when a party or customer directly indicates, via the user interface, that he or she has approved of or agreed to the bundling of the products. In an embodiment, an explicit indication that the product is eligible for bundling may be received from another computing device, such as when a computing system administrating the insurance policy explicitly indicates in a communication or message that the insurance policy is eligible for bundling, or when a computing system administrating the investment account explicitly indicates in a communication or message that the investment account is eligible for bundling.

In an embodiment, determining the eligibility of a product for bundling (block 102) includes receiving an implicit indication, e.g., a trigger. A trigger may cause a change of state of at least one of the insurance policy or the investment account which, in turn, may affect the eligibility or the ineligibility of the product for bundling. For example, a trigger indicating that a customer has opened an investment account via a website may be received, or a trigger indicating an agent has entered data indicating that an insurance policy has been approved by underwriting may be received. Based on the received trigger, a current state of one or more products may be updated, and based on the updated state(s), the product may be determined to be newly eligible or ineligible for bundling (block 102). In an embodiment, the implicit indication or trigger may be received from a remote computing device or system. For example, a computing system administrating the investment account may transmit a message or communication indicating that a balance of the account has exceeded a certain threshold, or a computing system administrating the insurance policy may transmit a message or communication indicating that an initial premium for an insurance policy has been received.

In an embodiment, determining the eligibility of a product for bundling (block 102) includes determining the values of one or more indicators corresponding to the status, state, characteristics, and/or conditions associated with the product. The values of the one or more indicators may be indicative of, for example, a status of the product and/or a presence or absence of one or more conditions or characteristics of the product, e.g., in a manner such as previously discussed.

In an embodiment, in addition to determining the eligibility of the first product for bundling with the second product (block 102), the method 100 may also include determining an eligibility of the second product for bundling with the first product to form the bundled set of products (block 105). Determining the eligibility of the second product for bundling with the first product to form the bundled set of products (block 105) may be performed using any of the techniques described above with respect to the block 102, for example. In some embodiments, the block 105 may be omitted from the method 100.

The method 100 may include generating an indication corresponding to the set of bundled products (block 108) based on the determined eligibility of the first product for bundling (block 102) and/or of the second product for bundling (block 105). For example, if the insurance policy is determined to be eligible for bundling, an indication that the insurance policy is eligible for bundling may be generated. If the insurance policy is determined to be ineligible for bundling, an indication that the insurance policy is ineligible for bundling may be generated. Similarly, if the investment account is determined to be eligible for bundling, an indication that the investment account is eligible for bundling may be generated, and if the investment account is determined to be ineligible for bundling, an indication that the investment account is ineligible for bundling may be generated.

In an embodiment, generating the indication corresponding to the set of bundled products (block 108) may include generating an indication that the eligibilities of the insurance policies and the investment account are such that the bundled set of products may be offered to the party or customer. For example, if the investment account was eligible for bundling prior to an execution of the method 100, and the method 100 determines that an insurance policy is newly eligible for bundling (block 102), generating the indication corresponding to the set of bundled products (block 108) may include generating an indication that a bundled product including the insurance policy and the investment account may be offered to the customer. In an embodiment, generating the indication corresponding to the set of bundled products (block 108) may include generating an indication that the set of bundled products has been automatically or manually formed or created from the investment account and the insurance policy.

In an embodiment, generating the indication corresponding to the set of bundled products (block 108) may include generating an indication of one or more bundling benefits corresponding to the set of bundled products. A bundling benefit may correspond to the investment account, to the insurance policy, or to both the investment account and the insurance policy. For example, a bundling benefit may include a discount, a reduction, or a waiver of a fee, a service charge, a sales charge, or a load of the investment account. A bundling benefit may include a higher rate of return or an increased dividend amount of the investment account, such as in situations when differentiating among shareholders of a particular share class is allowed. In another example, a bundling benefit may include a discount on, a reduction of, or a waiver of a premium for the insurance policy.

In yet another example, a bundling benefit may include an option to have a payout of a policy (e.g., a death benefit of a life insurance policy) allocated towards an investment account. In some situations, the payout may be allocated towards an investment account with a discount or a waiver of a fee, a service charge, a sales charge, or a load of the investment account.

In some embodiments, more than one bundling benefit may correspond to the set of bundled products. For example, the set of bundled products may result in both a reduction of a load of an investment account and a reduction of a premium amount for the insurance policy. In another example, the set of bundled products may result in both a reduction of the premium amount for the insurance policy and the ability of a payout of the insurance policy to be allocated to an investment account with no charge.

The indication of one or more bundling benefits may indicate that the one or more bundling benefits are available or able to be offered given the eligibilities of the insurance product and the investment account, in an embodiment. The indication of the one or more bundling benefits may indicate that the one or more bundling benefits have been enacted for the insurance policy and investment account, in an embodiment.

In an embodiment, a user (e.g., an agent of the insurance provider and/or an agent of the investment vehicle provider) may define, select and/or modify the bundling benefit(s) corresponding to the set of bundled products. For example, the user may define, select and/or modify a set of benefit rules that indicate the one or more bundling benefits corresponding to the bundled set of products. The set of benefit rules may vary for different types of insurance policies, different types of investment accounts, different combinations of types of insurance policies and types of investment accounts, different statuses of insurance policies and/or investment accounts, different characteristics and/or conditions of insurance policies and/or investment accounts, and/or different parties. Specific bundling benefits may be tied to certain aspects of the insurance policy and/or of the investment account, such as balances, the combination of the specific type of insurance policy and the specific type of investment account, coverage amounts, and the like.

In an embodiment, more than one of the above indications may be aggregated and generated as a single, comprehensive indicator, message or communication (block 108). In an embodiment, more than one indication corresponding to the bundled set of products may be generated (block 108).

The method 100 may include causing the indication corresponding to the set of bundled products to be transmitted to a user interface and/or to another computing device (block 110). For example, the indication may be caused to be transmitted to a user interface that is integral to the computing device on which at least a portion of the method 100 is being executed. In another example, the indication may be caused to be transmitted to a remote user interface, such as to a webpage or other user interface at a computing device of being used by a customer, an agent of the insurance policy, or an agent of the investment account.

In an embodiment, the indication may be caused to be transmitted to another computing device or system. For example, if the method 100 is at least partially being executed by a computing system that administrates the insurance policy, the indication may be caused to be transmitted to another local or remote computing system at which the investment account is administrated. In another example, if the method 100 is at least partially being executed by a computing system that administrates the investment account, the indication may be caused to be transmitted to another local or remote computing system at which the insurance policy is administrated. In some embodiments, the indication may be caused to be transmitted to both a system at which the insurance policy is administrated and to a system at which the investment account is administrated.

Although the method 100 has been generally discussed above with respect to eligibility for bundling, in an embodiment, in some embodiments, the method 100 may be additionally or alternatively executed with respect to ineligibility to bundling. For example, if a bundled product is in-force, the method 100 may be executed when one or more of the insurance policy or the investment account changes to state in which the insurance policy or the investment account is rendered ineligible for bundling (e.g., as determined at the block 102 and/or the block 105). For ineligibility scenarios, generating the indication corresponding to the bundled set of products (block 108) may include, for example, generating an indication that the insurance policy and/or the investment account is no longer eligible for bundling, and/or generating an indication that the insurance policy and the investment account have been unbundled.

In some embodiments, at least a portion of the method 100 may be periodically executed. For example, determining the eligibility of a product (e.g., the block 102 and/or the block 105) may be periodically or otherwise repeatedly executed over time. In an embodiment, the status of the insurance product and/or the status of the investment account may be continually or periodically monitored for any changes. In an embodiment, a computing device may be periodically queried for any changes in status or triggers that may cause changes in status to a product.

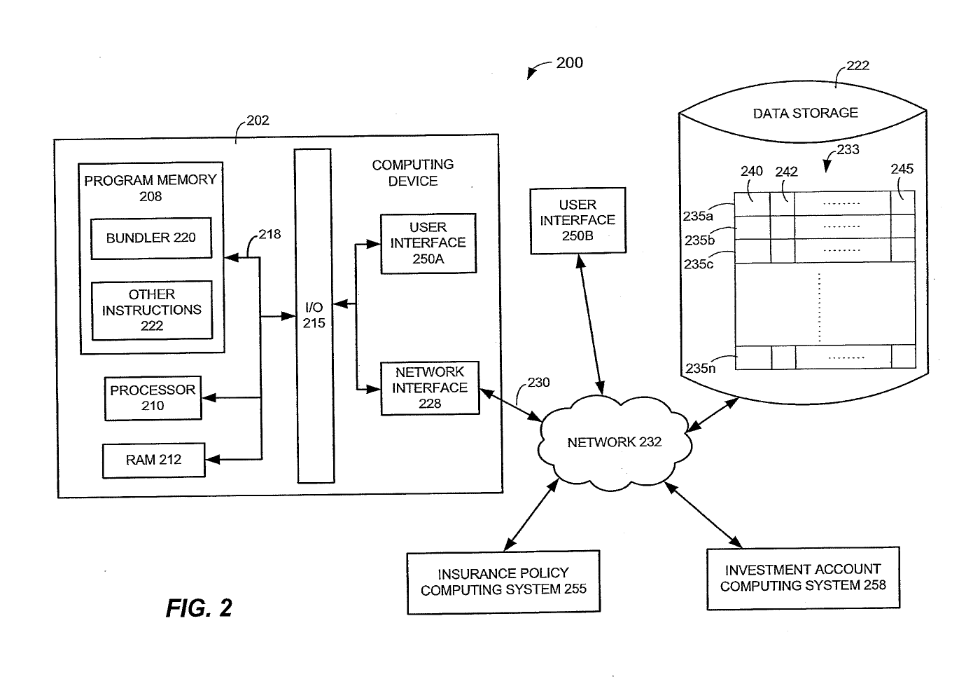

Turning now to FIG. 2, FIG. 2 illustrates a block diagram of an exemplary system 200 for bundling insurance policies and investment accounts. The system 200 may execute at least a portion of the method 100, in an embodiment. The system 200 may execute at least a portion of a method for bundling insurance policies and investment accounts other than the method 100, in an embodiment.

The system 200 may include a computing device 202 which may be, for example, a computer, a server, a plurality of networked computing devices having a logical appearance of a single computing device, a plurality of cloud computing devices, etc. Accordingly, for ease of discussion only and not for limitation purposes, the computing device 202 is referred to herein using the singular tense, although in some embodiments the computing device 202 may include more than one physical computing device.

The computing device 202 may include a program memory 208, a processor 210 (may be called a controller, a microcontroller, or a microprocessor), a random-access memory (RAM) 212, and an input/output (I/O) circuit 215, all of which may be interconnected via an address/data bus 218. The program memory 208 may comprise one or more tangible, non-transitory computer-readable storage media or devices, and may be configured to store computer-readable instructions 220 that, when executed by the processor 210, cause the computing device 202 to implement bundling of insurance policies and investment accounts. In an embodiment, the instructions 220, when executed, may cause the computing device 202 to implement at least a portion the method 100 of bundling insurance policies and investment accounts. For ease of discussion, the instructions 220 are referred to herein as “the bundler 220.”

The computing device 202 may be configured or adapted to access one or more data storage devices 222. For example, the bundler 220 may be executable by the processor 210 to access the one or more data storage devices 222. Additionally or alternatively, another set of computer-executable instructions 225 may be executable by the processor 210 to access the one or more data storage devices 222.

The one or more data storage devices 222 may comprise, for example, one or more memory devices, a data bank, cloud data storage, or one or more other suitable data storage devices. In the embodiment illustrated in FIG. 2, the computing device 202 is shown as being configured to access the one or more data storage devices 222 via a network interface 228 that is coupled to a link 230 in communicative connection with the one or more data storage devices 222. The link 230 in FIG. 2 is depicted as a link to one or more private or public networks 232 (e.g., the one or more data storage devices 222 are remotely located from the computing device 202), although this is not required. The link 230 may include a wired link and/or a wireless link, or may utilize any suitable communications technology.

In an embodiment (not shown), at least one of the one or more data storage devices 222 is included in the computing device 202, and the processor 210 of the computing device 202 (or the instructions 220, 225 being executed by the processor 210) accesses the one or more data storage devices 222 via a link comprising a read or write command, function, primitive, application programming interface, plug-in, operation, or instruction, or similar.

The one or more data storage devices 222 may include one physical device, or the one or more data storage devices 222 may include more than one physical device. The one or more data storage devices 222, though, may logically appear as a single data storage device irrespective of the number of physical devices included therein. Accordingly, for ease of discussion only and not for limitation purposes, the data storage device 222 is referred to herein using the singular tense.

The data storage device 222 may be configured or adapted to store data related to bundling system 200. In an embodiment, the data storage device 222 includes a database or other suitable data storage format 233 that includes one or more entries 235a-235n. Each entry 235 may correspond to a particular party. For example, the entry 235a corresponds to the party 240, which may be a person, a business, an organization, or another entity indicated by a value stored in the field 240. As such, the database or data storage 233 may be referred to as a “client registry” or a “customer registry,” for example.

Each entry 235 may include a first indicator configured or adapted to store a value indicative of a status of an insurance policy corresponding to the party, and a second indicator configured or adapted to store a value indicative of a status of an investment account corresponding to the party. For example, the entry 235a includes a first indicator 242 configured or adapted to store a value indicative of a current status of an insurance policy corresponding to the party 240, and a second indicator 245 configured or adapted to store a value indicative of a current status of an investment account corresponding to the party 240. In an embodiment, each entry 235 may include multiple investment account indicators corresponding to different investment accounts. In an embodiment, each entry may include multiple insurance policy indicators corresponding to different insurance policies.

In an embodiment, each entry 235 may additionally include one or more indicators whose values are indicative of the presence or absence of one or more characteristics or conditions corresponding to the eligibility and/or the ineligibility of the insurance policy and/or the investment account for bundling. For example, a third indicator (not shown) may correspond to a balance in the investment account, and a fourth indicator (not shown) may correspond to a delinquency or non-payment of the insurance policy premium. In an embodiment, the one or more indicators whose values are indicative of the presence or absence of one or more eligibility characteristics or conditions are omitted, and indications of the presence or absence of said characteristics or conditions are incorporated into the set of statuses able to be indicated by values stored by the first indicator 242 and/or into the set of statuses able to be indicated by values stored by the second indicator 245.

Indeed, each status indicator 242, 245 may indicate one of a respective set of statuses or states. The set of statuses or states that are applicable to an insurance policy may, in an embodiment, include only two statuses, e.g., “in-force” or “not in-force” (or similar). In an embodiment, the set of statuses or states for an insurance policy may include more than two statuses, e.g., “in-force,” “never applied for,” “applied for,” “at underwriting,” “approved,” “denied,” “lapsed,” “canceled,” “in-force but does not meet characteristic X required for bundling,” and/or other statuses. In an embodiment, at least some of the possible statuses for insurance policies may be selectable or defined by a user (e.g., an agent of a provider of insurance policies).

With regard to the statuses or states that are applicable to an investment account, the set of possible account statuses may, in an embodiment, include only two statuses, e.g., “open” and “closed” (or similar). In an embodiment, the set of statuses for an investment account may include more than two statuses, e.g., “never applied for,” “open,” “closed,” “frozen,” “open but does not meet criteria Y for bundling,” and/or other statuses. In an embodiment, at least some of the possible statuses for investment accounts may be selectable or defined by a user (e.g., an agent of a provider of investment vehicles).

Particular combinations of statuses 242, 245 may render the corresponding insurance policy and/or investment account eligible for bundling, and thus eligible for one or more bundling benefits corresponding to the set of bundled products. These combinations of product states may be selected, defined, and/or modified by a user (e.g., an agent of the insurance policy provider or the agent of the investment vehicle provider), in an embodiment. For example, the set of bundled products may be eligible for bundling benefits when the insurance policy has a status of “in-force” and the account has a status of “open and includes criteria Y.” In some embodiments, different combinations of states for different types of investment accounts and/or different types of insurance policies are eligible for bundling. For example, a whole life insurance policy may be eligible for bundling when its cash value exceeds a certain amount, whereas a term life insurance policy may be eligible for bundling if the coverage amount exceeds a threshold. In another example, certain criteria corresponding individual types of policies or accounts and otherwise required for bundling may be waived, e.g., when a customer has a total portfolio value across multiple investment accounts above a particular threshold.

In an embodiment, the data storage device 222 may store other data related to bundling insurance policies and investment accounts. For example, the data storage device 222 may store one or more sets of insurance policy bundling rules, one or more sets of investment account bundling rules, one or more sets of bundling benefit rules, security and access permissions, and/or other data corresponding to the bundling of insurance policies and investment accounts.

With further regard to FIG. 2, in an embodiment, the bundler 220 is configured or adapted to change or update the entries 235 and the values of the fields 240-245 included therein to reflect the current status of the insurance policies and investment accounts. Generally, the bundler 220 may administrate the entries 235 and the contents of the entries 235 to support the bundling of insurance policies and investment vehicles accounts. For example, the bundler 220 may create a new entry 235n corresponding to a new customer, or the bundler 220 may delete an entry 235b.

The bundler 220 may update a value of the field 242 storing the insurance policy status when a current state or status of the insurance policy changes. In an embodiment, the bundler 220 may change or update the entries 235 (or at least some portions of their contents and fields 242, 245) based on one or more explicit or implicit indications (e.g., triggers) received by the computing device 202. For example, the bundler 220 may receive an explicit indication or a trigger to change one or more of the entries 235 via a user interface 250. The user interface 250 may be integral to the computing device 202 (e.g., the user interface 250a), and/or the user interface may not be integral with the computing device 202 (e.g., the user interface 250b). For example, the user interface 250 may be a remote user interface 250b at a remote computing device, such as a web page or a client application.

In an embodiment, the bundler 220 may receive an explicit indication or a trigger to change to one or more of the entries 235 via a link 230 that is communicatively connected to another computing device or system 255, 258. In an embodiment, the computing device 202 may receive a trigger, signal or message via the link 230 (and, optionally, via one or more private or public networks 232) from a computing device or system 255 at which insurance policy information is maintained and/or administrated. For example, the computing system 255 may store additional data or information corresponding to the insurance policy, such as policy terms, records of premium payments, personal information of the policyholder, etc. In an embodiment, when insurance policy information is added, deleted, changed or updated at the computing system 255, the computing system 255 may correspondingly inform the bundler 220 via the link 230.

In an embodiment, the computing device 202 may receive a trigger or message via the link 230 (and, optionally, via one or more private or public networks 232) from a computing device or system 258 at which investment account information is maintained and/or administrated. For example, the computing system 258 may store additional data or information corresponding to the investment account such as account terms, records of accumulated interest, gains, distributions, or other transactions, personal information of the policyholder, etc. In an embodiment, when investment account information is added, deleted, changed or updated at the computing system 258, the computing system 258 may correspondingly inform the bundler 220 via the link 230.

In FIG. 2, although the computing device 202 is shown as being in communicative connection with a single computing system 255 corresponding to insurance policies, the computing device 202 may be in communicative connection to any number of computing systems 255 (e.g., zero, two, three, or more computing devices) corresponding to any number or types of insurance policies. For example, the computing device 202 may be in communicative connection with a first computing system corresponding to life insurance policies, and with a second system corresponding to auto insurance policies, and with yet a third system corresponding to homeowners' insurance policies. In an embodiment, the computing device 202 may be included in (e.g., integral with) a computing system 255 corresponding to insurance policies.

Further, although in FIG. 2 the computing device 202 is shown as being in communicative connection with a single computing system 258 corresponding to investment accounts, the computing device 202 may be in communicative connection to any number of computing systems 258 (e.g., zero, two, three, or more computing devices) corresponding to any number or types of investment accounts. For example, the computing device 202 may be in communicative connection with a computing system corresponding to mutual fund accounts, and with another system corresponding to checking and savings accounts, and with yet another system corresponding to retirement accounts. In an embodiment, the computing device 202 may be included in (e.g., integral with) a computing system 258 corresponding to investment accounts.

Turning again to the computing device 202, while the bundler 220 is shown as a single block in FIG. 2, it will be appreciated that the bundler 220 may include a number of different programs, modules, routines, and sub-routines that may collectively cause the computing device 202 to implement the bundler 220. It should be appreciated that although only one processor 210 is shown, the computing device 202 may include multiple processors 210. Additionally, although the I/O circuit 215 is shown as a single block, it should be appreciated that the I/O circuit 215 may include a number of different types of I/O circuits. Similarly, the memory of the computing device 202 may include multiple RAMs 212 and multiple program memories 208. Further, while the instructions for the bundler 220 and the other instructions 222 are shown being stored in the program memory 208, the instructions may additionally or alternatively be stored in the RAM 212 or other local memory (not shown).

The RAM(s) 212 and program memories 208 may be implemented as semiconductor memories, magnetically readable memories, chemically or biologically readable memories, and/or optically readable memories, or may utilize any suitable memory technology. The computing device 202 may also be operatively connected to the network 232 via the link 230 and the I/O circuit 215. The network 232 may be a proprietary network, a secure public internet, a virtual private network or some other type of network, such as dedicated access lines, plain ordinary telephone lines, satellite links, combinations of these, etc. Where the network 232 comprises the Internet, data communications may take place over the network 232 via an Internet communication protocol, for example.

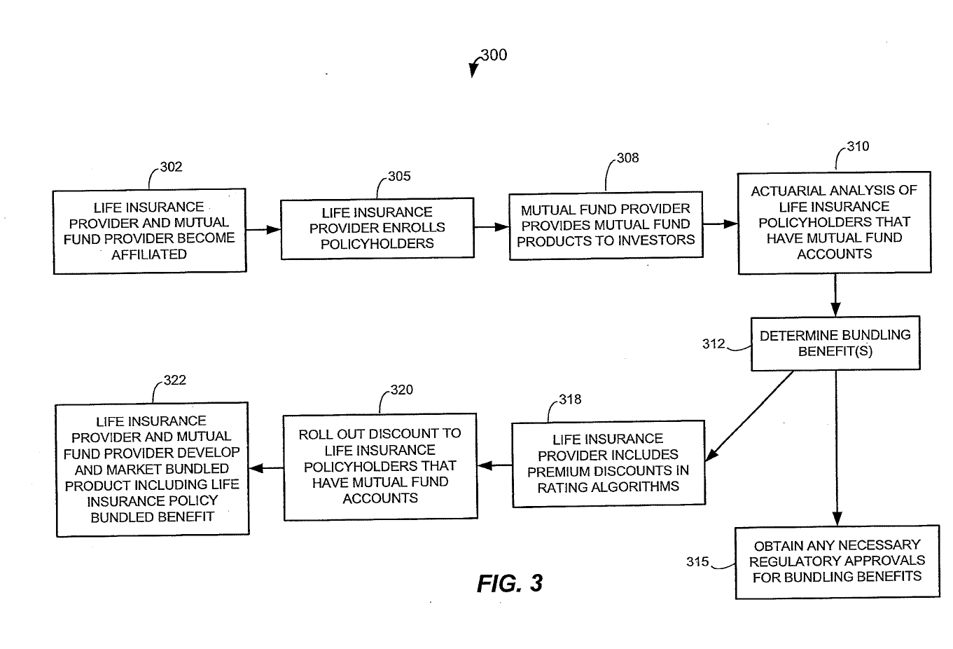

FIG. 3 illustrates an example scenario 300 in which insurance policies and investment vehicle accounts are bundled to provide a bundled benefit corresponding to an insurance policy. In an embodiment, the scenario 300 may occur, at least partially, by executing at least a portion or all of the method 100 of FIG. 1. Additionally or alternatively, the scenario 300 may be at least partially implemented by at least a portion or all of the system 200 of FIG. 2. In the example scenario 300, the insurance policies are shown as life insurance policies and the investment accounts are shown as mutual fund accounts, but the principles and techniques illustrated in FIG. 3 may equally be applied to other types of insurance policies and investment accounts.

Referring to block 302, a life insurance provider and a mutual fund provider may become affiliated. For example, if the life insurance provider and the mutual fund provider are two different, distinct companies, the providers may be affiliated by a joint operating or business agreement. In an embodiment, the life insurance provider and the mutual fund provider may be different subsidiaries, divisions, organizations, or groups within a parent company.

The life insurance provider may enroll one or more policyholders (block 305), and the mutual fund provider may provide accounts for mutual fund investors (block 308). In some embodiments, the block 308 may be executed prior to the block 305, and in some embodiments, the execution of the blocks 305 and 308 may overlap.

At block 310, an actuarial analysis of enrolled life insurance policyholders who also have open mutual fund accounts may be performed. In an embodiment, an actuarial analysis may be performed on a subset of the enrolled life insurance policyholders who also have open mutual fund accounts. For example, the subset of policyholders may be selected based on insurance policies, mutual fund accounts, and/or policyholders that meet particular statuses, conditions, and/or characteristics.

The results of the actuarial analysis may be utilized to determine one or more life insurance policy bundling benefits (block 312) to be offered to or provided to the set or subset of policyholders on which the actuarial analysis was performed. In the scenario 300, the determined life insurance policy bundling benefits include a discount or a waiver on an insurance premium, but other bundling benefits may alternatively or additionally be determined. Moreover, different bundling benefits may be determined for different policyholders depending on the actuarial analysis and on the statuses or states, conditions, and/or characteristics of a particular policyholder, his or her insurance policy, and/or his or her mutual fund account, in an embodiment.

At block 315, the life insurance provider and/or the mutual fund provider may obtain any necessary regulatory approvals needed to provide one or more life insurance policy bundling benefits. In FIG. 3, while the block 315 is illustrated as being executed after the benefit determination (block 312), the block 315 may be executed at any time during the scenario 300 prior to enacting the bundling benefits in the computing systems of the life insurance provider (block 318), and/or prior to rolling out the benefits to the policyholders (block 320).

The life insurance provider may include or incorporate the determined life insurance policy bundling benefits into its rating algorithms and/or other policy administration processes (block 318). In an embodiment, the life insurance provider may include or incorporate indications of the determined bundling benefits into a computing system with which the life insurance provider administrates insurance policies, e.g., the system 255 shown in FIG. 2.

In an embodiment, the life insurance provider may enact or roll out the life insurance policy bundled benefits to the life insurance policies (block 320). For example, the life insurance provider may enact or roll out the bundled benefits to the life insurance policies of the set of policyholders identified at the block 310. The life insurance policy bundled benefits may be offered to the policyholders, or the bundled benefit may be automatically enacted, e.g., in a subsequent premium or statement of the life insurance policy, or at any time after the benefits have received regulatory approval (block 315).

In some embodiments, the scenario 300 includes marketing the life insurance bundled benefit (block 322), for example, by the life insurance provider, the mutual fund provider, or both providers. It is noted that while the marketing (block 322) is illustrated in FIG. 3 as being executed at the end of the scenario 300, the marketing (block 322) may be executed at any time during the scenario 300 after the providers have been affiliated (e.g., after the block 302).

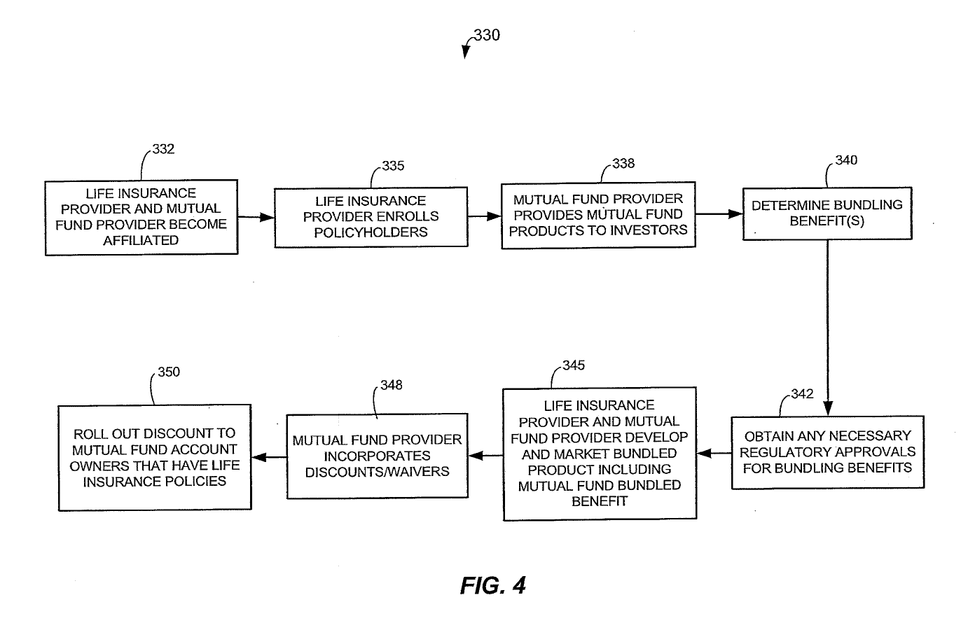

FIG. 4 illustrates an example scenario 330 in which life insurance policies and investment accounts are bundled to provide a bundled benefit corresponding to an account of an investment vehicle. In an embodiment, the scenario 330 may occur, at least partially, by executing at least a portion or all of the method 100 of FIG. 1. Additionally or alternatively, the scenario 330 may be at least partially implemented by at least a portion or all of the system 200 of FIG. 2. In some embodiments, the scenario 330 may be combined with at least portions of the scenario 300 of FIG. 3. In the example scenario 330, the insurance policies are shown as life insurance policies and the investment accounts are shown as mutual fund accounts, but the principles and techniques illustrated in FIG. 4 may equally be applied to other types of insurance policies and investment accounts.

Referring to block 332, a life insurance provider and a mutual fund provider may become affiliated. For example, if the life insurance provider and the mutual fund provider are two different, distinct companies, the providers may be affiliated by a joint operating or business agreement. In an embodiment, the life insurance provider and the mutual fund provider may be different subsidiaries, divisions, organizations, or groups within a parent company.

The life insurance provider may enroll one or more policyholders (block 335), and the mutual fund provider may provide accounts for mutual fund investors (block 338). In some embodiments, the block 338 may occur prior to the block 305, and in some embodiments, the occurrences of the blocks 335 and 338 may overlap.

One or more mutual fund bundling benefits to be offered to or provided to the set of mutual fund investors who also hold life insurance policies may be determined (block 340). In the scenario 330, the determined mutual fund bundling benefits may include a discount or a waiver on a load, a fee, a service charge or a sales charge corresponding to the mutual fund. Other bundling benefits, though, may alternatively or additionally be determined. Moreover, different bundling benefits may be determined for different investors depending on the statuses or states, conditions, and/or characteristics of a particular account owner, his or her insurance policy, and/or his or her mutual fund account, in an embodiment.

At block 342, the life insurance provider and/or the mutual fund provider may obtain any necessary regulatory approvals needed to provide one or more mutual fund account bundling benefits. In FIG. 4, while the block 342 is illustrated as occurring immediately after the determination of the bundling benefits (block 340), the block 342 may occur at any time during the scenario 330 prior to enacting the bundling benefits in the computing systems of the mutual fund provider (block 348), and/or prior to rolling out the benefits to the investment account owners (block 350).

In some embodiments, the scenario 330 includes marketing the mutual fund bundled benefit (block 345). For example, the life insurance provider, the mutual fund provider, or both providers may market the mutual fund bundled benefit. The marketing of the mutual fund bundling benefit (block 345) may be executed at any time during the scenario 330 after the providers have been affiliated (e.g., after the block 332).

The mutual fund provider may include or incorporate the determined mutual fund bundling benefits into its product administration algorithms and/or other processes (block 348). In an embodiment, the mutual fund provider may include or incorporate indications of the determined bundling benefits into a computing system with which the mutual fund provider administrates mutual fund accounts, e.g., the system 258 shown in FIG. 2.

In an embodiment, the mutual fund provider may enact or roll out the mutual fund bundled benefits to the accounts of mutual fund investors who also have life insurance policies that are in-force (block 350). The mutual fund bundled benefits may be offered to the said investors, or the mutual fund bundled benefit may be automatically enacted for the investors' accounts, e.g., with a subsequent transaction, or at any time after the benefits have received regulatory approval (block 342).

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and systems described herein are illustrative only and are not limiting upon the scope of the claims.

1. A system for bundling insurance policies and investment accounts, the system comprising:
one or more processors;
one or more data storage devices accessible to the one or more processors and configured to store an entry corresponding to a party, the entry including (i) an insurance policy status indicator configured to store a status of an insurance policy corresponding to the party, and (ii) an investment account status indicator configured to store a status of an investment account corresponding to the party; and
a program memory storing executable instructions that, when executed by the one or more processors, cause the system to update to at least one of (i) the insurance policy status indicator corresponding to a change in status of the insurance policy, or (ii) the investment account status indicator corresponding to a change in the status of the investment account,
wherein the update to the at least one of the insurance policy status indicator or the investment account status indicator causes at least one of (i) an indication of a bundling benefit to be presented at a user interface, (ii) the indication of the bundling benefit to be transmitted to another computing device, or (iii) the bundling benefit to be enacted.

2. The system of claim 1, wherein:
the one or more processors are included in one or more computing devices communicatively connected to the one or more data storage devices;
the one or more computing devices are configured to cause the at least one of (i) the indication of the bundling benefit to be presented at the user interface, (ii) the indication of the bundling benefit to be transmitted to the another computing device, or (iii) the bundling benefit to be enacted; and
the one or more data storage devices are further configured to store a plurality of entries corresponding to a plurality of parties.

3. The system of claim 1, wherein:
the executable instructions, when executed by the one or more processors, further cause the system to receive an indication of a trigger for at least one of the change in status of the insurance policy or the change in status of the investment account; and
the update to the at least one of the insurance policy status indicator or the investment account status indicator is based on the received indication of the trigger.

4. The system of claim 1, wherein:
the one or more data storage devices are further configured to store additional data corresponding to at least one of the insurance policy or the investment account;
the system further comprises one or more computing devices; and
the bundling benefit is enacted by the one or more computing devices.

5. The system of claim 1, wherein the party is at least one of a guarantor, a policy owner, an annuitant, a beneficiary, or an insured of the insurance policy.

6. The system of claim 1, wherein at least one of (i) the insurance policy is a life insurance policy, or (ii) the investment account is a mutual fund account.

7. The system of claim 1, wherein:
(i) the one or more data storage devices are further configured to store additional data corresponding to one of the insurance policy or the investment account, and the bundling benefit is enacted by the system; or
(ii) the another computing device is configured to store additional data corresponding to the other one of the insurance policy or the investment account, and the bundling benefit is enacted by the another computing device.

8. The system of claim 1, wherein the bundling benefit includes a reduction of at least one of a fee, a load, a sales charge, or a service charge of the investment account.

9. The system of claim 1, wherein a provider of the insurance policy is different from a provider of the investment account.

10. One or more tangible, non-transitory computer-readable storage media storing instructions for bundling insurance policies and investment accounts, wherein the instructions, when executed by one or more processors of a computer system, cause the computer system to:
access an entry stored in a tangible, non-transitory memory, the entry corresponding to a party and including (i) an insurance policy status indicator configured to store a status of an insurance policy corresponding to the party, and (ii) an investment account status indicator configured to store a status of an investment account corresponding to the party;
receive an indication of a trigger for at least one of a change in the status of the insurance policy corresponding to the party or a change in the status of the investment account corresponding to the party; and
based on the received indication of the trigger, update at least one of (i) the insurance policy status indicator to reflect the change in the status of the insurance policy, or (ii) the investment account status indicator to reflect the change in the status of the investment account,
wherein the update causes at least one of:
(i) an indication of a bundling benefit to be presented at a user interface,
(ii) the indication of the bundling benefit to be transmitted to another computing device, or
(iii) the bundling benefit to be enacted.

11. The one or more tangible, non-transitory computer-readable storage media of claim 10, wherein the computer system enacts the bundling benefit.

12. The one or more tangible, non-transitory computer-readable storage media of claim 10, wherein the another computing device enacts the bundling benefit.

13. The one or more tangible, non-transitory computer-readable storage media of claim 10, wherein the party is at least one of a guarantor, a policy owner, an annuitant, a beneficiary, or an insured of the insurance policy.

14. The one or more tangible, non-transitory computer-readable storage media of claim 10, wherein at least one of:
the insurance policy is a life insurance policy,
the investment account is a mutual fund account, or
a provider of the insurance policy is different from a provider of the investment account.

15. The one or more tangible, non-transitory computer-readable storage media of claim 10, wherein the entry stored in the tangible, non-transitory memory further includes additional data corresponding to at least one of the insurance policy or the investment account.

16. The one or more tangible, non-transitory computer-readable storage media of claim 10, wherein the bundling benefit includes a reduction of at least one of a fee, a load, a sales charge, or a service charge of the investment account.

17. The one or more tangible, non-transitory computer-readable storage media of claim 10, wherein the instructions, when executed by the one or more processors of the computer system, cause the computer system further to determine the bundling benefit based on the update.

18. A computer-implemented method for bundling insurance policies and investment accounts using one or more computing devices, the method comprising:
accessing, by one or more processors, an entry stored in a tangible, non-transitory memory, the entry corresponding to a party and including (i) an insurance policy status indicator configured to store a status of an insurance policy corresponding to the party, and (ii) an investment account status indicator configured to store a status of an investment account corresponding to the party;
receiving, at one or more processors, an indication of a trigger for at least one of a change in the status of the insurance policy corresponding to the party or a change in the status of the investment account corresponding to the party;
determining, by one or more processors and based on the received indication of the trigger, an update to at least one of the insurance policy status indicator to reflect the change in the status of the insurance policy, or the investment account status indicator to reflect the change in the status of the investment account;
causing, by one or more processors, the update to be applied to the entry in the tangible, non-transitory memory;
determining, by one or more processors and based on the update, a bundling benefit associated with at least one of the insurance policy or the investment account; and
causing, by the one or more processors, at least one of:
(i) an indication of the bundling benefit to be presented at a user interface,
(ii) the indication of the bundling benefit to be transmitted to another computing device, or
(iii) the bundling benefit to be enacted.

19. The computer-implemented method of claim 18, wherein:
causing the bundling benefit to be enacted comprises enacting, by the one or more processors, the bundling benefit; or
causing the bundling benefit to be enacted comprises causing the bundling benefit to be enacted by one or more processors of the another computing device.

20. The computer-implemented method of claim 18, wherein at least one of:
the party is at least one of a guarantor, a policy owner, an annuitant, a beneficiary, or an insured of the insurance policy;
the insurance policy is a life insurance policy;
the investment account is a mutual fund account;
the bundling benefit includes a reduction of at least one of a fee, a load, a sales charge, or a service charge of the investment account; or
a provider of the insurance policy is different from a provider of the investment account.
